(19) United States
(12) Patent Application Publication
(10) Pub. No.: US 2022/0020997 A1
(43) Pub. Date: Jan. 20, 2022

(54) ELECTRODE MATERIAL INCLUDING SILICON OXIDE AND SINGLE-WALLED CARBON NANOTUBES

(71) Applicant: NANOGRAF CORPORATION, Chicago, IL (US)

(72) Inventors: Joshua J. LAU, Chicago, IL (US); Robert CAVANAUGH, Chicago, IL (US); Pitawat MAHAWATTANANGUL, Chicago, IL (US)

(21) Appl. No.: 17/375,562

(22) Filed: Jul. 14, 2021

Related U.S. Application Data
(60) Provisional application No. 63/051,616, filed on Jul. 14, 2020.

(51) Int. Cl. H01M 4/62; H01M 4/58; H01M 4/38; H01M 10/0525

(52) U.S. Cl. CPC H01M 4/625; H01M 4/622; H01M 2004/021; H01M 4/381; H01M 10/0525; H01M 4/5825

(57) ABSTRACT

An electrode material for a lithium ion secondary battery contains an active material particles comprising an alkali metal or an alkali earth metal silicate, a binder, and single-walled carbon nanotubes (SWCNTs).

### TECHNICAL FIELD

Aspects of the present disclosure relate to electrode materials including silicon oxide and single-walled carbon nanotubes (SWCNTs), and in particular, to anodes including the electrode materials, and lithium ion batteries including the anodes.

### BACKGROUND

Lithium (Li) ion electrochemical cells typically require materials that enable high energy density, high power density and high cycling stability. Li ion cells are commonly used in a variety of applications, which include consumer electronics, wearable computing devices, military mobile equipment, satellite communication, spacecraft devices and electric vehicles, and are particularly popular for use in large-scale energy applications such as low-emission electric vehicles, renewable power plants, and stationary electric grids. Additionally, lithium-ion cells are at the forefront of new generation wireless and portable communication applications. One or more lithium ion cells may be used to configure a battery that serves as the power source for any of these applications. It is the explosion in the number of higher energy demanding applications, however, that is accelerating research for yet even higher energy density, higher power density, higher-rate charge-discharge capability, and longer cycle life lithium ion cells. Additionally, with the increasing adoption of lithium-ion technology, there is an ever increasing need to extend today's energy and power densities, as applications migrate to higher current needs, longer run-times, wider and higher power ranges and smaller form factors.

Active anode materials such as silicon are a desirable replacement for current graphite based anodes due to their high lithium storage capacity that can exceed 7× that of graphite (up to 3200 mAh/g). However, due to the large volume expansion of alloy particles upon lithiation, these anode materials typically exhibit extremely poor cycle life due to mechanical stress, low coulombic efficiency and electrical disconnection.

Accordingly, there is a need for an advanced anode active material for use in an electrochemical cell that incorporates carbon materials of defined quality characteristics that favorably impact electrochemical cell cyclability.

### SUMMARY

An embodiment of the present disclosure provides an electrode material for a lithium ion secondary battery which contains an active material particles comprising an alkali metal or an alkali earth metal silicate, a binder, and single-walled carbon nanotubes (SWCNTs). In one embodiment, the electrode material comprises, based on a total weight of the electrode material, at least about 80 wt % of a combination of graphite particles and the metal silicate particles, from about 1 wt % to about 5 wt % of a binder, and from about 0.05 wt % to about 1 wt % single-walled carbon nanotubes (SWCNTs).

### BRIEF DESCRIPTION OF THE DRAWINGS

FIG. 1A is a scanning electron microscope (SEM) image of an active material composite particle, according to various embodiments of the present disclosure, and FIGS. 1B-1D are sectional diagrams of core particles that may be included in a composite particle of FIG. 1A.

FIGS. 2A, 2B, and 2C illustrate Raman spectra for graphite and various graphene-based materials.

FIG. 3 is a bar chart comparing the Raman spectra I_{D}/I_{G} ratios of typical carbon materials to low-defect turbostratic carbon.

FIGS. 4A, 4B, and 4C illustrate the Raman spectra of electrode active materials comprising core particles respectively encapsulated by amorphous carbon, reduced graphene oxide (rGO), and low-defect turbostratic carbon.

FIGS. 5A and 5B are sectional, schematic views of a portion of an anode electrode of an embodiment in its as-fabricated state and after repeated charge-discharge cycles, respectively.

FIGS. 6A, 6B and 6C are graphs showing capacity retention of Exemplary and Comparative half-cells.

### DETAILED DESCRIPTION OF THE PREFERRED EMBODIMENTS

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention. It will also be understood that the term “about” may refer to a minor measurement errors of, for example, +/−5% to 10%.

Words such as “thereafter,” “then,” “next,” etc. are not necessarily intended to limit the order of the steps; these words may be used to guide the reader through the description of the methods. Further, any reference to claim elements in the singular, for example, using the articles “a,” “an” or “the” is not to be construed as limiting the element to the singular.

An “electrode material” is defined as a material that may be configured for use as an electrode within an electrochemical cell, such as a lithium ion rechargeable battery. An “electrode” is defined as either an anode or a cathode of an electrochemical cell. A “composite electrode material” is also defined to include active material particles combined with one of particles, flakes, spheres, platelets, sheets, tubes, fibers, or combinations thereof and that are of an electrically conductive material. The particles, flakes, spheres, platelets, sheets, tubes, fibers or combinations thereof may further be one of flat, crumpled, wrinkled, layered, woven, braided, or combinations thereof.

The electrically conductive material, may be selected from the group consisting of an electrically conductive carbon-based material, an electrically conductive polymer, graphite, a metallic powder, nickel, aluminum, titanium, stainless steel, and any combination thereof. The electrically conductive carbon-based material may further include one of graphite, graphene, diamond, pyrolytic graphite, carbon black, low defect turbostratic carbon, fullerenes, or combinations thereof. An “electrode material mixture” is defined as a combination of materials such as: material particles (either electrochemically active, electrically conductive, composite or combinations thereof), a binder or binders, a non-crosslinking and/or a crosslinking polymer or polymers, which are mixed together for use in forming an electrode for an electrochemical cell. An “electrochemically active material”, “electrode active material” or “active material” is defined herein as a material that inserts and releases ions such as ions in an electrolyte, to store and release an electrical potential. The term “inserts and releases” may be further understood as ions that intercalate and deintercalate, or lithiate and delithiate. The process of inserting and releasing of ions is also understood, therefore, to be intercalation and deintercalation, or lithiation and delithiation. An “active material” or an “electrochemically active material” or an “active material particle”, therefore, is defined as a material or particle capable of repeating ion intercalation and deintercalation or lithium lithiation and delithiation.

As defined herein a secondary electrochemical cell is an electrochemical cell or battery that is rechargeable. “Capacity” is defined herein as a measure of charge stored by a battery as determined by the mass of active material contained within the battery, representing the maximum amount of energy, in ampere-hours (Ah), which can be extracted from a battery at a rated voltage. Capacity may also be defined by the equation: capacity=energy/voltage or current (A)×time (h). “Energy” is mathematically defined by the equation: energy=capacity (Ah)×voltage (V). “Specific capacity” is defined herein as the amount of electric charge that can be delivered for a specified amount of time per unit of mass or unit of volume of active electrode material. Specific capacity may be measured in gravimetric units, for example, (Ah)/g or volumetric units, for example, (Ah)/cc. Specific capacity is defined by the mathematical equation: specific capacity (Ah/kg)=capacity (Ah)/mass (kg). “Rate capability” is the ability of an electrochemical cell to receive or deliver an amount of energy within a specified time period. Alternately, “rate capability” is the maximum continuous or pulsed energy a battery can provide per unit of time.

“C-rate” is defined herein as a measure of the rate at which a battery is discharged relative to its maximum nominal capacity. For example, a 1C current rate means that the discharge current will discharge the entire battery in 1 hour; a C/2 current rate will completely discharge the cell in 2 hours and a 2C rate in 0.5 hours. “Power” is defined as the time rate of energy transfer, measured in Watts (W). Power is the product of the voltage (V) across a battery or cell and the current (A) through the battery or cell. “C-Rate” is mathematically defined as C-Rate (inverse hours)=current (A)/capacity (Ah) or C-Rate (inverse hours)=1/discharge time (h). Power is defined by the mathematical equations: power (W)=energy (Wh)/time (h) or power (W)=current (A)×voltage (V). Coulombic efficiency is the efficiency at which charge is transferred within an electrochemical cell. Coulombic efficiency is the ratio of the output of charge by a battery to the input of charge.

Considerable development in both commercial and academic settings has been focused on designing systems that minimize or accommodate total volume swelling of alloy particles and associated electrochemical losses. This has typically been approached on two fronts. At the particle level, designing particle architectures that confine swelling to small domains to prevent particle fracture and electrical disconnection, and at the electrode level, designing a polymer matrix and conductive network that can accommodate the volume swell of the lithium storing materials while retaining mechanical and electronic integrity during repeated charge/discharge operation of the Li-ion cell.

A popular technique to stabilize the cycle life of alloy active anode materials such as silicon is through the mixture, encapsulation or other incorporation by various carbon materials to provide an electronically conducting surface and facilitate general electronic conduction throughout the electrode particle network. These include CVD amorphous carbon coatings, graphene wrappings, and physical mixing with graphite, conductive carbons, and carbon nanoplatelets. However, active materials may still swell due to their rigid nature and lack of long range order, and particles may still become isolated resulting in storage capacity loss and trapped lithium.

Various embodiments of the present disclosure provide an anode material for Li-ion batteries that includes active material particles comprising an alkali metal or an alkali earth metal silicate and single-wall carbon nanotubes (SWCNTs) that provide long range conductivity in the active material particle network, enabling increased cycle life stability despite the inherent swelling associated with the lithium storing metal alloy particles.

SiO Materials

Silicon and silicon alloys may significantly increase cell capacity when incorporated within an electrode of an electrochemical cell. Silicon and silicon alloys are often incorporated within an electrode comprising graphite, graphene, or other carbon-based active materials. Examples of electrodes comprising carbon-based materials and silicon are provided in U.S. Pat. Nos. 8,551,650, 8,778,538, and 9,728,773 to Kung et al., and U.S. Pat. Nos. 10,135,059 and 10,135,063 to Huang et al., all the contents of which are fully incorporated herein by reference.

Herein, “SiO” materials may refer to silicon and oxygen-containing materials. SiO materials are of interest for use in anode electrodes of lithium-ion batteries, due to having high theoretical energy and power densities. However, the utilization of current commercial SiO materials has been limited due to SiO materials having a low 1^{st} cycle efficiency and a high irreversibility. This low 1^{st} cycle efficiency is due to high irreversible Li⁺ reaction with the SiO matrix.

In order to decrease the irreversible Li⁺ reaction with silicon oxide, various embodiments include metalized silicon oxide materials (M-SiO). Herein, M-SiO materials may refer to active materials that are directly reacted with metal-containing precursors, such as alkali and/or alkali earth containing precursors, such as for example, lithium-containing precursors and/or magnesium-containing precursors, to form metalized silicon and oxygen-containing phases, prior to being utilized in a battery as an active material and/or undergoing charge and discharge reactions. In one embodiment, all or some of the metalizing metal may remain in the active material and does not intercalate (i.e., does not insert) or deintercalate during battery charging and discharging. However, in some embodiments, M-SiO materials may include SiO materials that are metalized to include other suitable alkali and/or alkali earth metals, such as sodium, potassium, calcium, or the like. For example, in some embodiments, M-SiO materials may be metalized to include magnesium, lithium, sodium, potassium, calcium, or any combinations thereof. Preferably, M-SiO materials may refer to lithium-metalized SiO (LM-SiO) materials and/or Mg-metalized SiO (MM-SiO) materials.

Electrode materials including M-SiO active materials have been found to provide increased 1^{st} cycle efficiency (FCE), as compared to non-metalized SiO materials. Unfortunately, M-SiO materials have been found to suffer from severe electrical disconnection and rapid capacity loss, often leading to more than 90% capacity fade within 20 cycles. Coating M-SiO materials with carbon and/or other materials, and/or blending M-SiO materials with graphite have been found to slightly reduce the electrical disconnection and capacity loss of active materials, delaying the over 50% capacity fade to ˜50 cycles, which is still highly unsatisfactory cycling stability for commercial applications. Overall, current M-SiO materials do not exhibit electrical stability sufficient for commercialization.

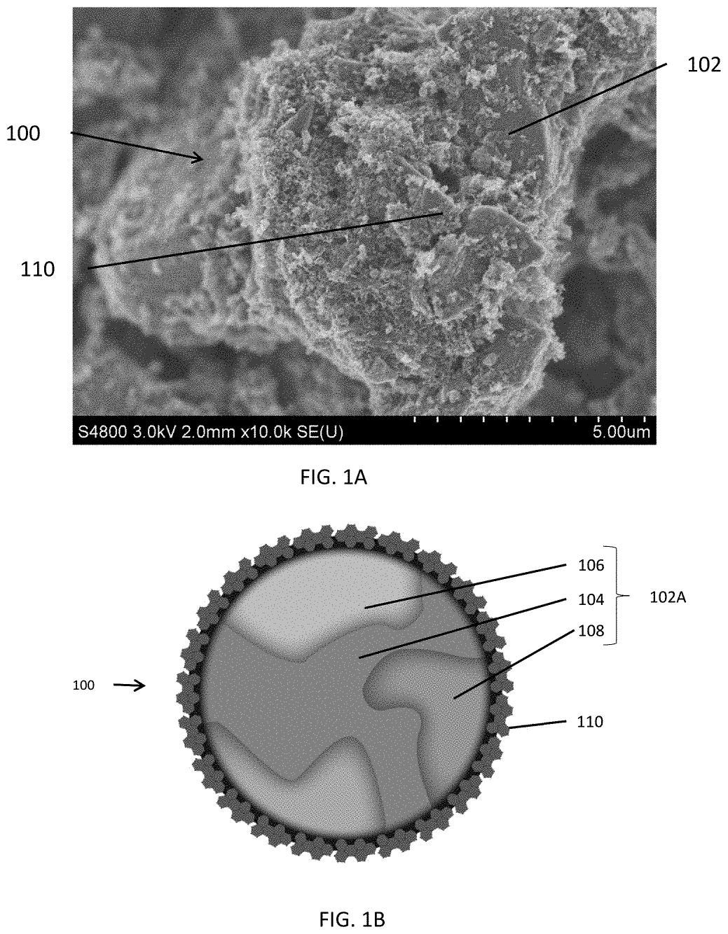

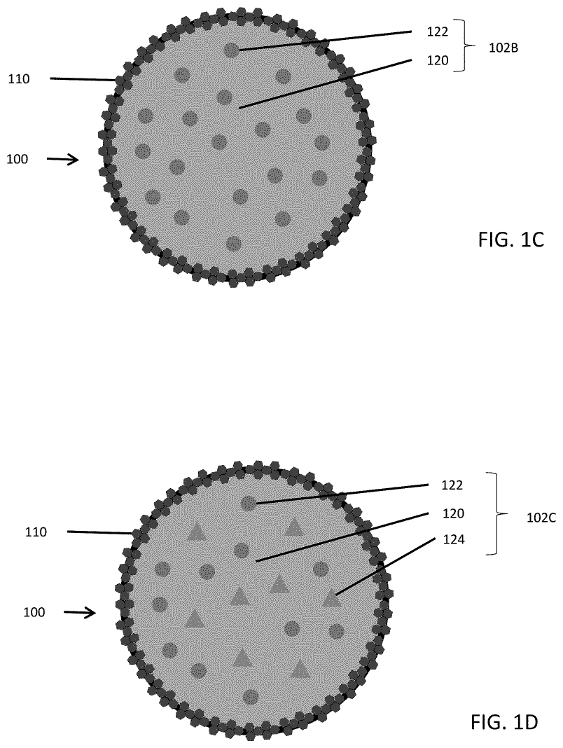

FIG. 1A is a scanning electron microscope (SEM) image of an active material particle 100, according to various embodiments of the present disclosure, FIGS. 1B-1D are a sectional diagrams of core particles 102A-102C that may be included in an active material particle 100 of FIG. 1A. Referring to FIGS. 1A and 1B, the active material particles 100 include a core particle 102 comprising an electrochemically active material, and a graphene-containing coating 110 that is coated on and/or encapsulates, the core particle 102.

In preferred embodiments, the core particle 102 comprises an M-SiO material. As such, the active material particles 100 are described below with respect to core particles 102 that comprise an M-SiO material.

The active material particles 100 and/or core particles 102 may have an average particle size that ranges from about 1 μm to about 20 μm, such as from about 2 μm to about 15 μm, from about 3 μm to about 10 μm, from about 3 μm to about 7 μm, or about 5 μm. The core particles 102 may include M-SiO materials that include metalized silicon species and silicon (e.g., crystalline and/or amorphous silicon). The metalized silicon species may include metalized silicides and metalized silicates. In some embodiments, the M-SiO materials may also include silicon oxide (SiOₓ, wherein x ranges from 0.8 to 1.2, such as from 0.9 to 1.1). In various embodiments, the M-SiO materials may include lithiated silicon species. Herein, “lithiated silicon species” may include lithium silicides (LiₓSi, 0<x<4.4), and/or one or more lithium silicates (Li₂Si₂O₅, Li₂SiO₃, and/or Li₄SiO₄, etc.).

Referring to FIG. 1B, in some embodiments, the active material particles 100 may include heterogeneous core particles 102A that include an M-SiO material that includes multiple silicon-containing material phases 104, 106, 108. For example, the phases 104, 106, 108 may independently comprise crystalline silicon, silicon oxide (e.g., SiOₓ, wherein x ranges from 0.8 to 1.2, such as from 0.9 to 1.1), and/or lithiated silicon species. However, in some embodiments the core particles 102 may be substantially homogeneous particles that lack distinct phases, but include silicon, oxygen and lithium.

Referring to FIG. 1C, in some embodiments, the active material particles 100 may comprise core particles 102B that include a primary phase 120, in which crystalline silicon domains 122 are dispersed as a secondary phase. For example, the primary phase 120 may include lithiated silicon species such as lithium silicate species, and in particular, Li₂Si₂O₅. In other embodiments, the primary phase 120 may comprise magnesium-metalized silicon species, such as magnesium silicate species, and in particular MgSiO₃, Mg₂SiO₄, combinations thereof, or the like. The crystalline silicon domains 122 may comprise crystalline silicon nanoparticles having a particle size of less than 100 nm. For example, the crystalline silicon domains 122 may have an average particle size ranging from about 3 nm to about 60 nm. In one embodiment, a majority of the crystalline silicon domains 122 may have an average particle size ranging from about 5 nm to about 10 nm, and a remainder of the crystalline silicon domains 122 may have an average particle size from about 10 nm to about 50 nm.

Referring to FIG. 1D, in some embodiments the active material particles 100 may comprise core particles 102C that include a primary phase 120 comprising an M-SiO material, and crystalline silicon domains 122 and SiOₓ domains 124 (e.g., SiOₓ, wherein x ranges from 0.8 to 1.2, such as from 0.9 to 1.1) dispersed in the primary phase 120 as secondary phases. For example, the primary phase 120 may include lithiated silicon species such as lithium silicate species, and in particular, Li₂Si₂O₅, the crystalline silicon domains 122 may comprise crystalline silicon nanoparticles, and the SiOₓ domains 124 may include SiOₓ phases and/or nanoparticles. The crystalline silicon domains 122 and the SiOₓ domains 124 may have a particle size of less than about 100 nm. For example, the crystalline silicon domains 122 and the SiOₓ domains 124 may have an average particle size ranging from about 3 nm to about 60 nm, such as from about 5 nm to about 50 nm.

In various embodiments, the core particles 102 may represent from about 80 wt % to about 99.5 wt %, such as from about 90 wt % to about 99 wt %, including about 90 wt % to 95 wt % of the total weight of the active material particles 100. In some embodiments the M-SiO material may include from about 40 at % to about 5 at %, such as from 20 at % to about 10 at %, or about 15 at % of lithiated silicon species. In some embodiments the M-SiO material of the core particles 102A may include from about 60 at % to about 95 at %, such as from about 80 at % to about 90 at %, or about 85 at % silicon and SiOₓ. The M-SiO material of the core particles 102 may have a silicon to oxygen atomic weight ratio ranging from about 1.25:1 to about 1:1.25, such as from about 1.1:1 to about 1:1.1, or of about 1:1. In some embodiments, the M-SiO material of the core particles 102 may comprise approximately equal atomic amounts of crystalline silicon and SiOₓ.

During an initial charging reaction and/or subsequent charging reactions, the composition of the M-SiO material of the core particles 102A may change due to lithiation and/or other reactions. For example, Si and SiOₓ may be lithiated to form LiₓSi domains. In addition, some SiOₓ may form inactive species, such as lithium silicates and Li₂O.

In various embodiments, the coating 110 may be in the form of a shell that completely encapsulates the core particles 102, as shown in FIGS. 1B-1D. However, in some embodiments, the coating 110 may only partially encapsulate some or all of the core particles 102. In some embodiments, the coating 110 may represent, based on the total weight of an active material particle, from about 0.5 wt % to about 20 wt %, such as from about 1 wt % to about 10 wt %, or from about 5 wt % to about 10 wt %, of the total weight of the active material particle 100.

Turbostratic Carbon

In some embodiments, the coating 110 may include a flexible, highly-conductive graphene material, such as graphene, graphene oxide, partially reduced graphene oxide, or combinations thereof. For example, the coating 110 may preferably comprise a flexible, highly conductive graphene material having low-defect turbostratic characteristics, which may be referred to as turbostratic carbon. The low-defect turbostratic carbon may be in the form of platelets comprising from one to about 10 layers of a graphene material, such as graphene, graphene oxide, or reduced graphene oxide. In some embodiments, the low-defect turbostratic carbon may comprise at least 90 wt %, such as from about 90 wt % to about 100 wt % graphene. The graphene material may further comprise a powder, particles, mono-layer sheets, multi-layer sheets, flakes, platelets, ribbons, quantum dots, tubes, fullerenes (hollow graphenic spheres) or combinations thereof.

The turbostratic carbon may be in the form of sheets or platelets that partially overlap to simulate larger size single sheet structures. In some embodiments the platelets have more than one or more layers of a graphene-based material. In some embodiments, the platelets may have sheet size may be on average ≤15 μm. In some embodiments, the platelets may have sheet size may be on average ≤1 μm. In some embodiments, the turbostratic carbon-based material platelets may have low thickness. In some embodiments, a low thickness of the turbostratic carbon-based material platelets may be on average ≤1 μm. In some embodiments, a low thickness of the turbostratic carbon-based material platelets may be on average ≤100 nm.

In various embodiments, the coating 110 may be in the form of a shell that completely encapsulates the particle 100, as shown in FIG. 1B. However, in some embodiments, the coating 110 may partially encapsulate some or all of the active material particles 100. In some embodiments, the coating 110 may represent from about 0.5 wt % to about 20 wt %, such as from about 1 wt % to about 10 wt %, or from about 5 wt % to about 10 wt %, of the total weight of the particles 100 and the coating 110.

The coating 110 may ensure that the core particles 102 are homogenously/uniformly cycled (movement of electrons and Li-ions in and out of the structure) in all three dimensions, due to its conductive nature, thereby minimizing the stresses exerted on and by the core particle and minimizing particle fracture. Additionally, in the event that a particle 100 does fracture, the flexible coating 110 may operate to electrically connect the fractured silicon oxide material and maintain the overall integrity of the particle 100, thereby leading to significantly improved electrochemical performance.

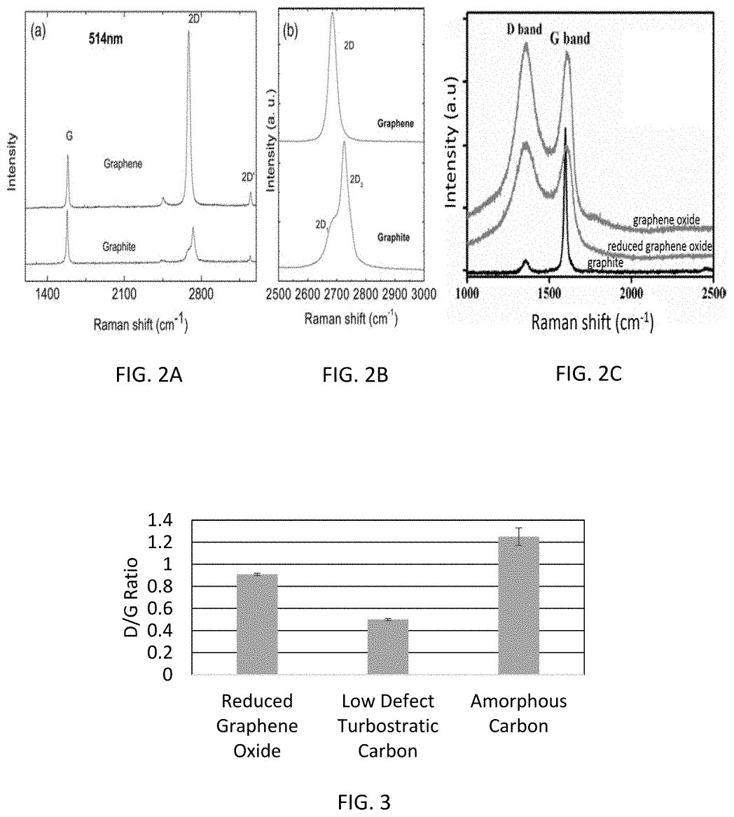

FIGS. 2A, 2B and 2C illustrate Raman spectra for graphite and various graphene-based materials. It has been well established that graphite and graphene materials have characteristic peaks at approximately 1340 cm⁻¹, 1584 cm⁻¹ and 2700 cm⁻¹. The peak at 1340 cm⁻¹ is shown in FIG. 2C, and is characterized as the D band. The peak at 1584 cm⁻¹ is shown in the spectra of FIGS. 2A and 2C, and is characterized as the G band, which results from the vibrational mode represented by the C═C bond stretching of all pairs of sp² hybridized carbon atoms. The D band originates from a hybridized vibrational mode associated with graphene edges and it indicates the presence of defects or broken symmetry in the graphene structure. The peak at 2700 cm⁻¹ is shown in FIG. 2B, and is characterized as the 2D band, which results from a double resonance process due to interactions between stacked graphene layers. The emergence of a double peak at the 2D wavenumber breaks the symmetry of the peak, and is indicative of AB stacking order between graphene planes in graphite and graphite derivatives such as nanoplatelets. The 2D1 peak shown in FIG. 1B becomes suppressed when the AB stacking order in turbostratic multilayer graphene particles is disrupted. The positions of the G and 2D bands are used to determine the number of layers in a material system. Hence, Raman spectroscopy provides the scientific clarity and definition for electrochemical cell carbon material additives, providing a fingerprint for correct selection as additives for active material electrode compositions. As will be shown, the present definition provides that fingerprint for the low-defect turbostratic carbon of the present application. It is this low-defect turbostratic carbon when used as an additive to an electrochemical cell electrode active material mixture that provides superior electrochemical cell performance.

FIG. 3 provides the I_{D}/I_{G} ratio of carbon additives typically used in prior art electrode active material mixtures (i.e., reduced graphene oxide or amorphous carbon) compared with the low-defect turbostratic carbon of the present application.

Reduced graphene oxide (rGO) is a carbon variant that is often referred to as graphene in the industry, however, is unique in final structure and manufacturing process. Graphene oxide is typically manufactured first using a modified Hummers method wherein a graphite material is oxidized and exfoliated into single layers or platelets comprising a few layers of carbon that may comprise various functional groups, including, but not limited to, hydroxyls, epoxides, carbonyls, and carboxyls. These functional groups are then removed through chemical or thermal treatments that convert the insulating graphene oxide into conductive reduced graphene oxide. The reduced graphene oxide is similar to graphene in that it consists of single layers of carbon atom lattices, but differs in that it has mixed sp2 and sp3 hybridization, residual functional groups and often increased defect density resultant from the manufacturing and reduction processes. Reduced graphene oxide is shown in the first bar of FIG. 3 and has an I_{D}/I_{G} ratio of 0.9.

Amorphous carbon is often used as an additive or surface coating for both electrochemical cell anode and cathode material mixtures to enhance electrode conductivity. Typically, amorphous carbons are produced using a chemical vapor deposition (CVD) process wherein a hydrocarbon feedstock gas is flowed into a sealed vessel and carbonized at elevated temperatures onto the surface of a desired powder material. This thermal decomposition process can provide thin amorphous carbon coatings, on the order of a few nanometers thick, which lack any sp2 hybridization as found in crystalline graphene-based materials. Amorphous carbon is shown in the third bar of FIG. 3 and has an I_{D}/I_{G} ratio >1.2.

Low-defect turbostratic carbon, also referred to as graphene, comprises unique characteristics resultant from its manufacturing processing. One common method of producing this material is through a plasma based CVD process wherein a hydrocarbon feedstock gas is fed through an inert gas plasma in the presence of a catalyst that can nucleate graphene-like carbon structures. By controlling the production parameters, carbon materials having a few layers and absent any AB stacking order between lattices can be produced. These carbon materials are typically highly ordered sp2 carbon lattices with low-defect density.

The low-defect turbostratic carbon of the present disclosure is shown in the center second bar of FIG. 3. The Raman spectrum of the low-defect turbostratic carbon additive of the present application is derived from the intensity ratio of the D band and the G band (I_{D}/I_{G}) and the intensity ratio of the 2D band and the G band (I_{2D}/I_{G}). The I_{D}, I_{2D}, and I_{G} are represented by their respective integrated intensities. A low I_{D}/I_{G} ratio indicates a low-defect material. The low-defect turbostratic carbon material of the present invention has an I_{D}/I_{G} ratio of greater than zero and less than or equal to about 0.8, as determined by Raman spectroscopy with I_{G} at wavenumber in a range between 1580 and 1600 cm⁻¹, I_{D} at wavenumber in a range between 1330 and 1360 cm⁻¹, and being measured using an incident laser wavelength of 532 nm. Additionally, the low-defect turbostratic carbon material of the present disclosure exhibits an I_{2D}/I_{G} ratio of about 0.4 or more. As reference regarding the I_{2D}/I_{G} ratio, an I_{2D}/I_{G} ratio of approximately 2 is typically associated with single layer graphene. I_{2D}/I_{G} ratios of less than about 0.4 is usually associated with bulk graphite consisting of a multitude of AB stacked graphene layers. Hence, the I_{2D}/I_{G} ratio of about 0.4 or more, for the low-defect turbostratic carbon material of the present disclosure, indicates a low layer count of <10. The low-defect turbostratic carbon material of low layer count further lacks an AB stacking order between graphene layers (i.e., turbostratic). The turbostratic nature or lack of AB stacking of these graphene planes is indicated by the symmetry of the I_{2D} peak. It is the symmetry of the 2D peak that distinguishes a turbostratic graphene layered material from an AB stacked graphene layered material, and is indicative of rotational stacking disorder versus a layered stacking order.

Carbon materials with high AB stacking order will still exhibit 2D peaks, however, these 2D peaks exhibit a doublet that breaks the symmetry of the peak. This break in symmetry is exhibited in both AB stacked graphene of a few layers or graphite of many layers. Thus, the 2D peak, which is a very strong indicator of the presence of stacking order regardless of the number of graphene layers present in the material, is of significance when selecting a graphene or graphene-based additive. It is the rotational disorder of the stacking in the low-defect turbostratic carbon of the present disclosure that distinguishes itself from all the other graphene or graphene-based additives used to date, as the rotational disorder of the low-defect turbostratic carbon stacking of the present application is what offers flexibility to the carbon-based particles of the present application, which therein enables the ability of these carbon-based particles to provide and preserve contact with the active core particle of the composite particles comprising the electrode of the electrochemical cell. The result is an electrochemical cell having increased cycle life, better cycle life stability, enhanced energy density, and superior high rate performance.

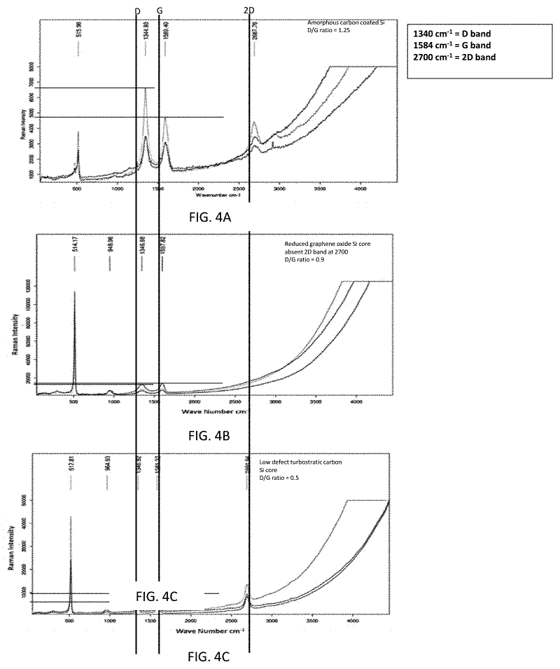

FIGS. 4A-4C illustrate Raman spectra for active material mixtures comprising SiO particles encapsulated by or coated with a carbon material. FIG. 4A is a graph of the Raman spectra for an active material mixture comprising SiO core particles coated with an amorphous carbon material. FIG. 4B is a graph of the Raman spectra for an active material mixture comprising SiO core particles encapsulated by rGO. FIG. 4C is a graph showing the Raman spectra for an active material mixture comprising core particles encapsulated by a low-defect turbostratic carbon. Each spectra is different because of varying layer thickness (size, shape and position of 2D peak around wavelength 2700 cm⁻¹) and disorder (size of D peak around wavelength 1340 cm⁻¹).

Raman analysis sample preparation involved taking small aliquots of powders such as active material powders, composite material powders, carbon material powder, and placing these powders individually into a clean glass vial. The sample powder is rinsed with methanol. The powder/methanol solutions are then vortexed briefly and sonicated for approximately 10 minutes. The suspension is then transferred to a microscope slide with a micropipette. The slides are then allowed to air dry completely before conducting the analysis.

The Raman spectroscopy analysis of the present application is conducted using confocal Raman spectroscopy on a Bruker Senterra Raman System under the following test conditions: 532 nm laser, 0.02 mW, 50× objective lens, 90 second integration time, 3 co-additions (3 Raman spectroscopy sample runs) using a 50×1000 μm aperture and a 9-18 cm⁻¹ resolution. As a point of reference, the D band is not active in the Raman scattering of perfect crystals. The D band becomes Raman active in defective graphitic materials due to defect-induced double resonance Raman scattering processes involving the π-π electron transitions. The intensity of the D band relative to the G band increases with the amount of disorder. The intensity I_{D}/I_{G} ratio can thereby be used to characterize a graphene material.

The D and G bands of the amorphous carbon shown in FIG. 4A are both of higher intensity than either the reduced graphene oxide (rGO) D and G bands of FIG. 4B or the turbostratic carbon D and G bands of FIG. 4C. The amorphous carbon also exhibits a substantially higher I_{D}/I_{G} ratio (1.25) than do rGO and turbostratic carbon. The suppressed intensity of the amorphous carbon G band compared to that of its D band reflects the lack of crystallinity (also known as its graphitic nature) within its carbon structure. The D peak intensity being higher than the G peak intensity is caused by the high amount of defects in the amorphous carbon network. Hence, the amorphous carbon spectra exhibits low crystallinity and a much higher degree of disorder in its graphitic network compared with more crystalline carbons, such as graphene, graphene oxide, and rGO. Moreover, the higher intensity of the rGO D peak compared with its G peak, and its higher I_{D}/I_{G} ratio (almost 2×) compared to the turbostratic carbon D and G peak intensities and I_{D}/I_{G} ratio indicates the rGO to have more defects than the turbostratic carbon of the present application.

Table 1 below provides the detail for the Raman spectra of FIGS. 4A-4C.

TABLE 1

| rGO | D | G | 2D | I_{D}/I_{G} | I_{2D}/I_{G} |
|---|---|---|---|---|---|
| Cm⁻¹ | 1346.98 | 1597.82 | — | | |
| Intensity | 9115.5 | 10033.3 | — | .91 | — |
| LowDefect | D | G | 2D | I_{D}/I_{G} | I_{2D}/I_{G} |
| Turbostratic | | | | | |
| Carbon | | | | | |
| Cm⁻¹ | 1346.92 | 1581.32 | 2691.9 | | |
| Intensity | 2915.3 | 5849.98 | 6009.4 | 0.5 | 1.03 |
| Amorphous | D | G | 2D | I_{D}/I_{G} | I_{2D}/I_{G} |
| Carbon | | | | | |
| Cm⁻¹ | 1344.93 | 1589.40 | 2695.4 | | |
| Intensity | 6194.8 | 4908.2 | 5238.5 | 1.25 | 1.07 |

Careful inspection of these spectra show that when disorder increases, the D band broadens and the relative intensity of the band changes. For the amorphous carbon coated sample, the high intensity (6194.8) and broad D peak indicates a high amount of defects. The G peak being lower in intensity (4908.2) then the D peak (6194.8) indicates a lack of crystallinity. The D peak intensity (9115.5) and G peak intensity (10033.3) of the rGO encapsulated sample are fairly alike. Noticeable, however, is that the D peak intensity (9115.5) of the rGO sample is substantially higher than the D peak intensity (2915.3) of the turbostratic carbon sample indicating that the rGO sample has substantially higher defect density than does the turbostratic carbon sample. Also noticeable is that the G band for the amorphous carbon and the rGO samples are shifted to the right of wavelength 1584 cm⁻¹ to wavelength 1589.4 cm⁻¹ and 1597.82 cm⁻¹ respectively, whereas the G band for the turbostratic carbon sample lies slightly to the left of wavelength of 1584 cm⁻¹ at 1581.32 cm⁻¹. Of significance is that, unlike the amorphous carbon and the rGO samples, the turbostratic carbon (in this case, graphene sample) does not display much, if any, shift in position, reflecting low-defects therein, thus, the turbostratic carbon sample most nearly resembles an almost ‘perfect’ turbostratic carbon material.

Electrode Materials

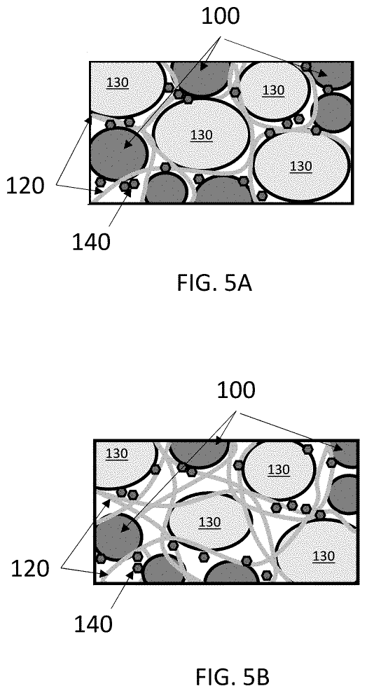

Various embodiments of the present disclosure provide electrode materials for Li-ion batteries, and in particular, anode electrode compositions. As shown in FIG. 5A, the electrode material may include an active material, a binder (not shown), and single-wall carbon nanotubes (SWCNTs) 120. The active material may include the above described active material particles 100 and optionally additional graphite particles 130. In some embodiments, the electrode materials may optionally include a conductive additive, such as carbon black particles 140. The active material particles 100 and the graphite particles 130 may be mixed with each other. The carbon black particles 140 may be smaller (i.e., have a smaller diameter) than the active material particles 100 and the graphite particles 130, and may be located between and/or on surfaces of the active material particles 100 and/or the graphite particles 130. The SWCNTs 120 may extend between the mixture of active material particles 100 and the graphite particles 130 and provide long range conductivity across multiple active particles (100, 130).

As shown in FIG. 5B, after numerous charge and discharge cycles, the silicon oxide particles 100 and the graphite particles 130 may swell and push away from each other. However, the SWCNTs 120, due to their large length and high aspect ratio, still contact and electrically connect multiple active material particles 100 and graphite particles 130. Thus, the SWCNTs 120 are believed to provide a percolating network (e.g., web or mesh above a percolation threshold) of conductive links between the active particles which provides sufficient conductivity to the anode electrode.

The electrode materials may include at least 80 wt % of the active material, such as at least 90 wt %, at least 94 wt %, such as 90 to 96.5 wt % of the active material. The active material may include a mixture of active material particles 100 and optionally graphite particles 130. For example, the active material may include from about 5 wt % to about 50 wt %, such as from about 10 wt % to about 30 wt %, from about 15 wt % to about 25 wt % M-SiO, and from about 95 wt % to about 50 wt %, such as from about 90 wt % to about 70 wt %, from about 85 wt % to about 75 wt % graphite. In some preferred embodiments, the active material may include less than 50 wt % M-SiO and more than 50 wt % graphite. Thus, the active material may include more graphite particles 130 than active material particles 100 by weight.

The active material particles 100 may include silicon and metal silicate phases and optionally silicon oxide phases described above. The active material particles 100 may include the optional carbon coating 110, or the carbon coating 110 may be omitted.

The active material particles 100 may have an average particle size that ranges from about 1 μm to about 20 μm, such as from about 1 μm to about 10 μm, from about 3 μm to about 7 μm, or about 5 μm. The active material particles 100 may have a surface area that ranges from about 0.5 m²/g to about 30 m²/g, such as from about 1 m²/g to about 20 m²/g, including from about 5 m²/g to about 15 m²/g.

The graphite may include graphite particles 130 of synthetic or natural origin. The graphite may have an average particle size ranging from about 2 μm to about 30 μm, such as from about 10 μm to about 20 μm, including from about 12 μm to about 18 μm. In one embodiment, the average particle size of the graphite particles 130 may be larger than the average particle size of the silicon oxide particles 100. The graphite particles 130 may have a surface area that ranges from about 0.5 m²/g to about 2.5 m²/g, such as from about 1 m²/g to about 2 m²/g. The graphite particles 130 may be larger than the silicon oxide particles 110.

The electrode material may include any suitable electrode material binder (not shown in FIGS. 5A and 5B for clarity). For example, the electrode material may include a polymer binder such as polyvinylidene difluoride (PVDF), Na-carboxymethyl cellulose (CMC), styrene butadiene rubber (SBR), polyacrylic acid (PAA), lithium polyacrylate (LiPAA), a combination thereof, or the like. In some embodiments, the binder may include a combination of the CMC and the SBR, where the CMC has a molecular weight from 250 to 850 g/mol and a degree of substitution from 0.65 to 0.9.

In various embodiments, the electrode material may include from about 1 wt % to about 5 wt %, or from about 2 wt % to about 3 wt % binder.

The SWCNTs 120 may have an average length of greater than about 1 μm. For example, the SWCNTs may have an average length ranging from about 1 μm to about 500 μm, such as from about 1 μm to about 10 μm. The SWCNTs may have an average diameter ranging from about 0.5 nm to about 2.5 nm, such as from about 1 nm to about 2 nm.

The SWCNTs 120 may have an I_{G}/I_{D} ratio or greater than about 5, such as greater than about 6 or greater than about 10, as determined by Raman spectroscopy, with I_{G} being associated with the Raman intensity at wavenumber 1580-1600 cm⁻¹, and I_{D} being associated with the Raman intensity at wavenumber 1330-1360 cm⁻¹, as measured using an incident laser wavelength of 633 nm.

In various embodiments, the electrode material may include from about 0.05 wt % to about 1 wt %, such as from about 0.075 wt % to about 0.9 wt %, from about 0.08 wt % to about 0.25 wt %, or about 0.1 wt % SWCTNs.

The conductive additive (i.e., conductive agent) may include carbon black (e.g., KETJENBLACK or Super-P carbon black), low defect turbostratic carbon, acetylene black, channel black, furnace black, lamp black, thermal black or combinations thereof. The conductive additive may optionally include metal powder, fluorocarbon powder, aluminum powder, nickel powder; nickel flakes, conductive whiskers, zinc oxide whiskers, potassium titanate whiskers, conductive metal oxides, titanium oxide, conductive organic compounds, conductive polyphenylene derivatives, conductive polymers, or combinations thereof.

In various embodiments, the electrode material may include from 0 to about 5 wt %, such as from about 0.1 wt % to about 5 wt %, including from about 0.25 wt % to about 3 wt %, from about 0.5 wt % to about 1.5 wt %, or about 1 wt % conductive additive (i.e., conductive agent) selected from carbon black, an electrically conductive polymer, a metallic powder, or any combination thereof. In some embodiments, the conductive additive may preferably include carbon black.

Anode Formation

According to various embodiments, an anode may be formed using any suitable method known to one or skill in the art. For example, active material particles 100 described above may be mixed with graphite particles 130 to form an active material. In one embodiment, the active material may include less than 50 wt % M-SiO and more than 50 wt % graphite. The active material may be mixed with the SWCNTs, binder and the optional conductive additives to form a solids component. In some embodiments, the active material particles may be coated with turbostratic carbon coating 110 using, for example, a spray drying process, prior to forming the active material. Alternatively, the coating 110 may be omitted.

The solids component may be mixed with a polar solvent such as water or N-Methyl-2-pyrrolidone (NMP), at a solids loading between about 20-60 wt %, to form an electrode slurry. For example, the mixing may include using a planetary mixer and high shear dispersion blade, under vacuum.

The electrode slurry may then be coated onto a metal substrate, such as a copper or stainless steel substrate, at an appropriate mass loading to balance the lithium capacity of the anode with that of a selected cathode. Coating can be conducted using a variety of apparatus such as doctor blades, comma coaters, gravure coaters, and slot die coaters.

After coating, the slurry may be dried to form an anode. For example, the slurry may be dried under forced air, at a temperature ranging from room temperature to about 120° C. The dried slurry may be pressed to reduce the internal porosity, and the electrode may be cut to a desired geometry. Typical anode pressed densities can range from about 1.0 g/cc to about 1.7 g/cc depending on the composition of the electrode and the target application. Cathode pressed densities may range from about 2.7 to about 4.7 g/cc.

In some embodiments, the active material particles may be coated with turbostratic carbon prior to forming the active material. For example, a mixture of active material particles, turbostratic carbon and a solvent may be spray dried, to form a powder, and the powder may then be heat-treated in an inert atmosphere, such as argon gas, to carbonize any remaining surfactant or dispersant. In other embodiments, the active material particles may be coated with turbostratic carbon using a binder and a mechano-fusion process.

Electrochemical Cell Assembly

Construction of an electrochemical cell involves the pairing of a coated anode substrate and a coated cathode substrate that are electronically isolated from each other by a polymer and/or a ceramic electrically insulating separator. The electrode assembly is hermetically sealed in a housing, which may be of various structures, such as but not limited to a coin cell, a pouch cell, or a can cell, and contains a nonaqueous, ionically conductive electrolyte operatively associated with the anode and the cathode. The electrolyte is comprised of an inorganic salt dissolved in a nonaqueous solvent and more preferably an alkali metal salt dissolved in a mixture of low viscosity solvents including organic esters, ethers and dialkyl carbonates and high conductivity solvents including cyclic carbonates, cyclic esters and cyclic amides. A non-limiting example of an electrolyte may include a lithium hexafluorophosphate (LiPF₆) or lithium bis(fluorosulfonyl)imide (LiFSi) salt in an organic solvent comprising one of: ethylene carbonate (EC), diethyl carbonate (DEC), dimethyl carbonate (DMC), fluoroethylene carbonate (FEC) or combinations thereof.

Additional solvents useful with the embodiment of the present invention include dialkyl carbonates such as tetrahydrofuran (THF), methyl acetate (MA), diglyme, trigylme, tetragylme, 1,2-dimethoxyethane (DME), 1,2-diethoxyethane (DEE), 1-ethoxy, 2-methoxyethane (EME), ethyl methyl carbonate, methyl propyl carbonate, ethyl propyl carbonate, dipropyl carbonate, and combinations thereof. High permittivity solvents that may also be useful include cyclic carbonates, cyclic esters and cyclic amides such as propylene carbonate (PC), butylene carbonate, acetonitrile, dimethyl sulfoxide, dimethyl formamide, dimethyl acetamide, gamma-valerolactone, gamma-butyrolactone (GBL), N-methyl-2-pyrrolidone (NMP), and combinations thereof.

The electrolyte may also include one or more additives, such as vinylene carbonate (VC), 1,3-propane sulfone (PS), prop-1-ene-1,3-sultone (PES), Flouroethylene carbonate (FEC), and/or propylene carbonate (PC). The electrolyte serves as a medium for migration of lithium ions between the anode and the cathode during electrochemical reactions of the cell, particularly during discharge and re-charge of the cell. The electrochemical cell may also have positive and negative terminal and/or contact structures.

### Experimental Examples

The following examples relate to anode formed using electrode materials of various embodiments of the present disclosure and comparative electrode materials, and are given by way of illustration and not by way of limitation. In the examples, % is percent by weight, g is gram, CE is coulombic efficiency, and mAh/g is capacity.

Exemplary Cells 1-3 (E1, E2, E3)

The active material, SWCNTs, a conductive agent (carbon black), and a binder (CMC/SBR) were mixed to form a solids component. The solids component was mixed with a polar solvent (water or NMP), at a solids loading of between 20 wt % and 60 wt %, in a planetary mixer having a high shear dispersion blade, under vacuum, to form electrode material slurries.

The electrode material slurries were coated on copper current collectors at an appropriate mass loading to balance the lithium capacity of the anode with that of a selected cathode, dried, and pressed to form anodes. The anodes were assembled into half-cells (excess counter electrode material=lithium metal) and electrolyte was provided into each of the half-cells, to form Exemplary Cells 1-3. The anodes of Exemplary Cells 1-3 each included 96 wt % active material, 0.1 wt % SWCNTs, 0.9 wt % carbon black, and 3 wt % CMC/SBR binder.

The anode of Exemplary Cell 1 included 20 wt % LM-SiO, and 76 wt % graphite. The anode of Exemplary Cell 2 included 30 wt % LM-SiO, and 66 wt % graphite. The anode of Exemplary Cell 3 included 30 wt % unmetallized SiO and 66 wt % graphite.

Comparative Cells 1-4 (C1, C2, C3, C4)

Comparative Cells 1-4 were formed in the same manner as Exemplary Cells 1-3. The anode of Comparative Cell 1 included 20 wt % LM-SiO, 76 wt % graphite, 1 wt % carbon black, and did not include CNTs. The anode of Comparative Cell 2 included 30 wt % LM-SiO, 66 wt % graphite, 0.9 wt % carbon black, and 0.1 wt % multi-walled carbon nanotubes (MWCNTs).

The anode of Comparative Cell 3 included 30 wt % LM-SiO, 66 wt % graphite, 1 wt % carbon black, and did not include CNTs. The anode of Comparative Cell 4 included 30 wt % unmetallized SiO, 66 wt % graphite, 1 wt % carbon black, and did not include CNTs.

The following Table 2 shows a half cell cycling protocol applied to the Exemplary and Comparative cells.

TABLE 2
Half Cell Cycling Protocol

| | |
|---|---|
| Voltage Window | 0.02-1.5 V |
| Formation | 0.05 C Lithiation \| 0.05 C Delithiation |
| | 0.1 C Lithiation \| 0.1 C Delithiation |
| | 0.5 C Lithiation \| 0.5 C Delithiation |
| | 0.5 C Lithiation \| 1 C Delithiation |
| | 0.5 C Lithiation \| 2 C Delithiation |
| Cycling | 0.5 C Lithiation \| 0.5 C Delithiation |
| Rest | 15 minutes between every charge/discharge step |

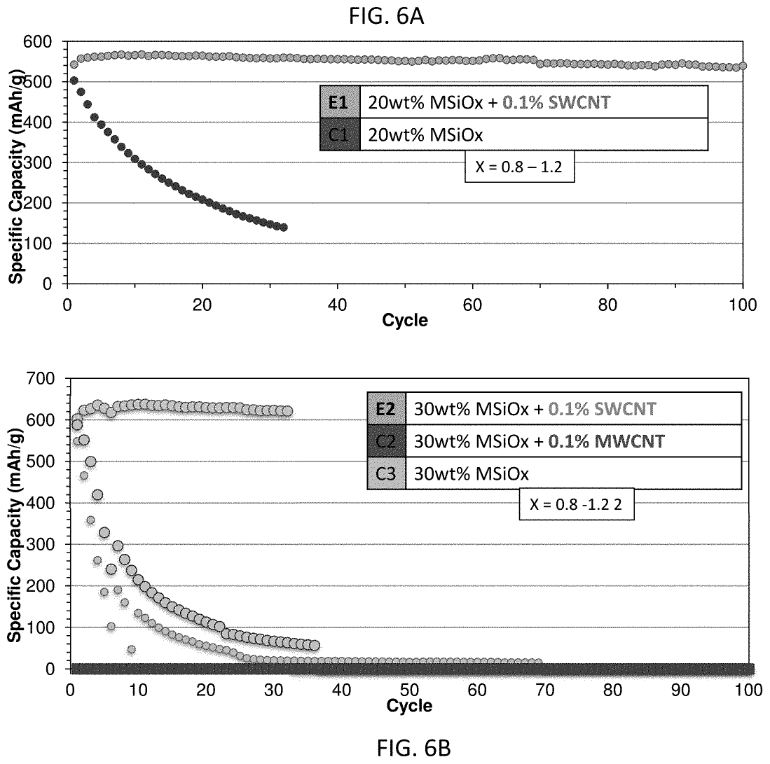

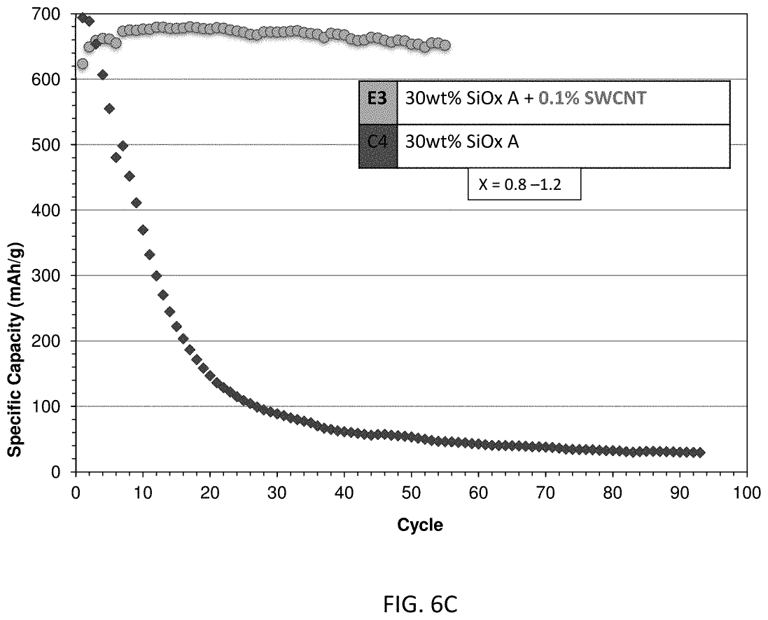

FIG. 6A is a graph showing the specific capacity retention of Exemplary Cell 1 and Comparative Cell 1, during cycling. As can be seen in FIG. 6A, Exemplary Cell 1, which included SWCNTs, had excellent capacity retention for 100 cycles. In contrast, Comparative Cell 1, which did not include SWCNTs, lost more than 50% of its initial capacity in fewer than 20 cycles.

FIG. 6B is a graph showing the specific capacity retention of Exemplary Cell 2 and Comparative Cells 2 and 3, during cycling. As can be seen in FIG. 6B, Exemplary Cell 2, which included SWCNTs, had excellent capacity retention. In contrast, Comparative Cells 2 and 3, which respectively included MWCNTs or did not include CNTs, exhibited a greater than 50% capacity loss in fewer than 10 cycles.

FIG. 6C is a graph showing the specific capacity retention of Exemplary Cell 3 and Comparative Cell 4, during cycling. As can be seen in FIG. 6C, Exemplary Cell 4, which included SWCNTs and unmetallized SiO, rather than LM-SiO, showed excellent capacity retention. In contrast, Comparative Cell 4, which included unmetallized SiO and no CNTs exhibited a capacity loss of approximately 50% in 10 cycles.

Accordingly, mixing with SWCNTs with M-SiO and graphite improves the coulombic efficiency and cycle life of the silicon anode by buffering the volume change of silicon particles during charge/discharge and lowers measurable swelling of the electrode. The addition of SWCNTs to an electrode composition provides relatively long-range conductivity across multiple electrode particles that is flexible enough to sustain a conducting network as particles in the electrode swell. This results in improved capacity retention as the Li-ion cell/electrode is charged and discharged during operation.

The long range conductivity provided by the SWCNTs also unexpectedly enables higher loading of high capacity alloy active materials, preventing capacity fade via electrical disconnection despite more severe overall electrode swelling.

The addition of SWCNTs can also reduce the total carbon black content added for electronic conductivity which consequently reduces the total surface area of the electrode and the amount of polymer binder added for mechanical integrity. Furthermore, carbon black is a nanomaterial that is pore-blocking, occupying interstitial space in between lithium storing active materials. High concentrations of carbon black are undesirable because they prevent proper calendaring (compressing) of the electrodes. Both a reduction in binder content and increase in calendared density provide significant benefits in enabled high energy density Li-ion cells.

Although the foregoing refers to particular preferred embodiments, it will be understood that the invention is not so limited. It will occur to those of ordinary skill in the art that various modifications may be made to the disclosed embodiments and that such modifications are intended to be within the scope of the invention. All of the publications, patent applications and patents cited herein are incorporated herein by reference in their entirety.

What is claimed is:

1. An electrode material for a lithium ion secondary battery, comprising:
an active material particles comprising an alkali metal or an alkali earth metal silicate;
a binder; and
single-walled carbon nanotubes (SWCNTs).

2. The electrode material of claim 1, wherein the electrode material comprises, based on a total weight of the electrode material:
at least about 80 wt % of a combination of graphite particles and the active material particles;
from about 1 wt % to about 5 wt % of a binder; and
from about 0.05 wt % to about 1 wt % of the single-walled carbon nanotubes (SWCNTs).

3. The electrode material of claim 2, wherein the SWCNTs have an average diameter ranging from about 0.5 nm to about 2.5 nm and an average length greater than 1 μm.

4. The electrode material of claim 3, wherein:
the SWCNTs have an I_{G}/I_{D} ratio or greater than about 5, as determined by Raman spectroscopy, and an average length ranging from about 10 μm to about 500 μm; and
the electrode material comprises from about 0.08 wt % to about 0.25 wt % of the SWCNTs.

5. The electrode material of claim 2, electrode material comprises from about 90 wt % to about 96.5 wt % of the combination of the graphite particles and the active material particles.

6. The electrode material of claim 5, wherein the active material comprises:
from about 50 wt % to about 95 wt % of the graphite particles; and
from about 5 wt % to about 50 wt % of the active material particles.

7. The electrode material of claim 6, wherein the active material comprises:
from about 70 wt % to about 90 wt % of the graphite particles; and
from about 10 wt % to about 30 wt % of the active material particles.

8. The electrode material of claim 6, wherein:
the graphite particles have an average particle size ranging from about 2 μm to about 30 μm and a surface area ranging from about 0.5 m²/g to about 2.5 m²/g;
the active material particles have an average particle size ranging from about 1 μm to about 20 μm, and a surface area ranging from about 0.5 m²/g to about 30 m²/g; and
the graphite particles have a larger average particle size than the core particles.

9. The electrode material of claim 2, wherein the active material particles comprise:
a primary phase comprising Li₂Si₂O₅, Li₂SiO₃, Li₄SiO₄, or any combination thereof; and
crystalline silicon domains dispersed in the primary phase.

10. The electrode material of claim 9, wherein the active material particles further comprise SiOₓ domains dispersed within the primary phase, where x ranges from 0.8 to 1.2.

11. The electrode material of claim 9, wherein:
the primary phase comprises Li₂Si₂O₅; and
the crystalline silicon domains have an average particles size less than 100 nm.

12. The electrode material of claim 2, wherein the active material particles comprise:
a primary phase comprising MgSiO₃, Mg₂SiO₄, or a combination thereof; and
crystalline silicon domains dispersed within the primary phase.

13. The electrode material of claim 2, wherein the binder comprises polyvinylidene difluoride (PVDF), Na-carboxymethyl cellulose (CMC), styrene butadiene rubber (SBR), polyacrylic acid (PAA), lithium polyacrylate (LiPAA), or a combination thereof.

14. The electrode material of claim 13, wherein the binder comprises a combination of the CMC and SBR.

15. The electrode material of claim 2, wherein the electrode material further comprises from about 0.1 wt % to about 5 wt % of a conductive agent selected from carbon black, an electrically conductive polymer, a metallic powder, or any combination thereof.

16. The electrode material of claim 15, wherein the conductive agent comprises carbon black powder having a smaller average particle size than a particle size of the active material particles and the graphite particles.

17. The electrode material of claim 1, wherein the SWCNTs form a percolating network of conductive links between the active material particles.

18. The electrode material of claim 1, wherein the active material particles comprise a coating comprising turbostratic carbon having a Raman spectrum having:
a D band having a peak intensity (I_{D}) at wave number between 1330 cm⁻¹ and 1360 cm⁻¹;
a G band having a peak intensity (I_{G}) at wave number between 1580 cm⁻¹ and 1600 cm⁻¹; and
a 2D band having a peak intensity (I_{2D}) at wave number between 2650 cm⁻¹ and 2750 cm⁻¹, wherein:
a ratio of I_{D}/I_{G} ranges from greater than zero to about 1.1; and
a ratio of I_{2D}/I_{G} ranges from about 0.4 to about 2.

19. A lithium secondary battery comprising:
an anode comprising the electrode material of claim 1;
a separator;
a cathode; and
an electrolyte disposed between the anode and cathode.

20. The battery of claim 19, wherein the SWCNTs reduce electrical disconnection of the active material particles during charging and discharging of the lithium secondary battery.
